(19) United States
(12) Patent Application Publication
(10) Pub. No.: US 2025/0199360 A1
(43) Pub. Date: Jun. 19, 2025

(54) DISPLAY MODULE AND DISPLAY DEVICE

(71) Applicants: Beijing BOE Display Technology Co., Ltd., Beijing (CN); BOE TECHNOLOGY GROUP CO., LTD., Beijing (CN)

(72) Inventors: Changjia FU, Beijing (CN); Xinrui WANG, Beijing (CN); Haijun SHI, Beijing (CN); Bochang WANG, Beijing (CN)

(73) Assignees: Beijing BOE Display Technology Co., Ltd., Beijing (CN); BOE TECHNOLOGY GROUP CO., LTD., Beijing (CN)

(21) Appl. No.: 18/844,225

(22) PCT Filed: Apr. 26, 2023
(86) PCT No.: PCT/CN2023/090886

§ 371 Date: Mar. 11, 2025

(30) Foreign Application Priority Data
Apr. 27, 2022 (CN) 202210458141.2

(51) Int. Cl. G02F 1/1335; G02F 1/1333; G02F 1/13357; G02F 1/1339

(52) U.S. Cl. CPC G02F 1/133614; G02F 1/13336; G02F 1/1335; G02F 1/133606; G02F 1/133608; G02F 1/1339; G02F 2202/28

(57) ABSTRACT

A display module is provided in the embodiment of the present disclosure, the display module includes: a display panel and a middle frame, the display panel includes a liquid crystal cell and a quantum dot composite film, the quantum dot composite film is on a main surface of the liquid crystal cell; the middle frame is on a side of the quantum dot composite film away from the liquid crystal cell, in which a sealing structure is arranged on an edge of the quantum dot composite film, the sealing structure can prevent the water vapor from entering the quantum dot composite film, to reduce the risk of adverse problems such as module image bluing produced by an edge failure of the quantum dot composite film, which can avoid reducing the quality of the display module image, and will not affect the color gamut of the display panel.

The present application claims priority of the Chinese Patent Application No. 202210458141.2 filed on Apr. 27, 2022, the content of which is incorporated in its entirety as portion of the present application by reference herein.

### TECHNICAL FIELD

Embodiments of the present disclosure provide a display module and a display device.

### BACKGROUND

A display device formed by a splicing screen is applied more and more widely, and the display device including the splicing screen is usually formed by splicing of multiple independent display modules. The display device including the splicing screen usually includes multiple splicing seams. The display module includes a display panel and a backlight module. Each of the splicing seams is formed by the edges of two backlight modules of two adjacent display modules, that is, a width of the splicing seam is equal to a sum of widths of the edges of the two backlight modules, and the width of the splicing seam of the display device including the splicing screen is usually greater than 3 mm. Since the width of the splicing seam of the display device including the splicing screen is usually larger, the display effect of the display device including the splicing screen is usually poor at present.

For example, in a backlight structure, a diffusion plate and each of the optical films are assembled with a plastic frame through a snap or a glue dispensing. The inner wall of the plastic frame will form a bright line due to the reflection, and an overlapping portion of the diffusion plate and the plastic frame will form a dark band. In a narrow frame design, due to the differences of brightness, a bright edge and a dark edge on the edge of the screen are formed, especially in the splicing screen product or an ultra-narrow frame product and other products, it will seriously affect the quality of the display device including the splicing screen.

### SUMMARY

At least one embodiment of the present disclosure provides a display module, the display module includes a display panel, and the display panel includes a liquid crystal cell and a quantum dot composite film, a sealing structure is arranged on an edge of the quantum dot composite film, and the sealing structure can prevent water vapor from entering the quantum dot composite film which results in quantum dot failure.

At least one embodiment of the present disclosure provides a display module, the display module includes a display panel, which includes a liquid crystal cell and a quantum dot composite film, in which the quantum dot composite film is arranged on a main surface of the liquid crystal cell; and a middle frame, arranged on a side of the quantum dot composite film away from the liquid crystal cell, in which a sealing structure is arranged on an edge of the quantum dot composite film.

For example, in the display module provided by at least one embodiment of the present disclosure, the quantum dot composite film comprises a function layer and a quantum dot film layer which are stacked.

For example, in the display module provided by at least one embodiment of the present disclosure, the function layer at least comprises a first brightness enhancement layer and a haze adjustment layer, the quantum dot film layer is sandwiched between the first brightness enhancement layer and the haze adjustment layer, the first brightness enhancement layer is configured to increase brightness of the display module, and the haze adjustment layer is configured to adjust haze of the display module.

For example, in the display module provided by at least one embodiment of the present disclosure, the first brightness enhancement layer is arranged on a side of the haze adjustment layer close to the liquid crystal cell.

For example, in the display module provided by at least one embodiment of the present disclosure, in a direction from the quantum dot composite film to the liquid crystal cell, the brightness enhancement layer comprises a brightness enhancement film, a diffusion film, and a prism film stacked sequentially.

For example, in the display module provided by at least one embodiment of the present disclosure, the function layer further comprises a second brightness enhancement layer arranged on a side of the first brightness enhancement layer away from the quantum dot film layer, and the second brightness enhancement layer is configured to increase the brightness of the display module.

For example, in the display module provided by at least one embodiment of the present disclosure, the quantum dot composite film is attached to the main surface of the liquid crystal cell by a first adhesive.

For example, in the display module provided by at least one embodiment of the present disclosure, the haze adjustment layer is entirely adhered to a side of the quantum dot film layer away from the display panel by a second adhesive, and the first brightness enhancement layer is entirely attached to a side of the quantum dot film layer close to the display panel by a third adhesive.

For example, in the display module provided by at least one embodiment of the present disclosure, the first adhesive, the second adhesive and the third adhesive comprise at least one of hot meld adhesive and UV curing adhesive respectively.

For example, in the display module provided by at least one embodiment of the present disclosure, a haze of the haze adjustment layer is from about 50% to 95%.

For example, in the display module provided by at least one embodiment of the present disclosure, the haze adjustment layer is made of polyethylene terephthalate, a surface of the haze adjustment layer comprises diffusion particles and an average particle diameter of the diffusion particles is from 3 μm to 50 μm.

For example, in the display module provided by at least one embodiment of the present disclosure, a side surface of the display panel and a side surface of the middle frame are provided with a light shielding tape.

For example, in the display module provided by at least one embodiment of the present disclosure, the display panel is connected with the middle frame by a fourth adhesive.

For example, in the display module provided by at least one embodiment of the present disclosure, a thickness of the fourth adhesive in a direction perpendicular to the main surface of the display panel is from 0.2 mm to 0.5 mm, and a length of the fourth adhesive in a direction parallel to the main surface of the display panel is from 0.5 mm to 1 mm.

For example, in the display module provided by at least one embodiment of the present disclosure, a width of the middle frame close to a surface of the display panel is from 0.2 mm to 0.5 mm.

For example, in the display module provided by at least one embodiment of the present disclosure, a distance between the sealing structure and an edge of the liquid crystal cell located in a same side as the sealing structure is from 0 to 0.2 mm.

For example, in the display module provided by at least one embodiment of the present disclosure, in a direction perpendicular to the main surface of the display panel, a thickness of the sealing structure is equal to or substantially equal to a thickness of the quantum dot composite film, and the sealing structure covers an edge of the quantum dot composite film.

For example, in the display module provided by at least one embodiment of the present disclosure, the display panel further comprises a first polarizer provided on a side of the liquid crystal cell close to the quantum dot composite film, and the quantum dot composite film is adhered to the first polarizer by a first adhesive.

For example, in the display module provided by at least one embodiment of the present disclosure, the display panel further comprises a second polarizer provided on a side of the liquid crystal cell away from the quantum dot composite film.

For example, the display module provided by at least one embodiment of the present disclosure, further comprises a light source structure and a back plate, in which the back plate comprises a first sub-back plate in parallel to or substantially in parallel to the main surface of the display panel, and the light source structure is arranged on a side of the first sub-back plate close to the display panel.

For example, in the display module provided by at least one embodiment of the present disclosure, a light emitting unit is provided between the light source structure and the first sub-back plate.

For example, in the display module provided by at least one embodiment of the present disclosure, a reflection film is provided on a side of the first sub-back plate close to the display panel, the reflection film has an interval region, and the light source structure is arranged in the interval region.

For example, in the display module provided by at least one embodiment of the present disclosure, the back plate further comprises a second sub-back plate in parallel to or substantially in parallel to an extension direction of the middle frame, and the middle frame is connected with the second sub-back plate by a connection part.

At least one embodiment of the present disclosure further provides a display device, and the display device includes a splicing screen formed by a plurality of display modules according to any one of the embodiments mentioned above.

### BRIEF DESCRIPTION OF DRAWINGS

In order to more clearly explain the technical solution of the embodiments of the present disclosure, the accompanying drawings of the embodiments will be briefly introduced below. Obviously, the accompanying drawings in the following description only relate to some embodiments of the present disclosure, and are not limited to the present disclosure.

FIG. 1 is a schematic diagram of a section structure of a display module;

FIG. 2 is a schematic diagram of a section structure of a display module provided by at least one embodiment of the present disclosure;

FIG. 3 is a schematic diagram of a section structure of a liquid crystal cell provided by at least one embodiment of the present disclosure;

FIG. 4 is a schematic diagram of a section structure of a quantum dot composite film provided by at least one embodiment of the present disclosure;

FIG. 5 is a schematic diagram of a section structure of a first brightness enhancement layer provided by at least one embodiment of the present disclosure;

FIG. 6 is a schematic diagram of a section structure of another function layer provided by at least one embodiment of the present disclosure;

FIG. 7 is a schematic diagram of a section structure of another display module provided by at least one embodiment of the present disclosure;

FIG. 8 is a schematic diagram of a section structure of a display panel provided by at least one embodiment of the present disclosure;

FIG. 9 is a schematic diagram of a plane structure of a display device provided by at least one embodiment of the present disclosure; and

FIG. 10 is a schematic diagram of a section structure of a display device provided by at least one embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect,” “connected,” etc., are not intended to define a physical connection or a mechanical connection, but may comprise an electrical connection, directly or indirectly. “Up,” “down,” “left,” “right,” and so on are only used to represent relative positional relationships. When the absolute position of the described object changes, the relative positional relationship may also change accordingly.

FIG. 1 is a schematic diagram of a section structure of a display module. As illustrated in FIG. 1, the display module 10 comprises a back plate 11, a middle frame 12, a light source structure 13, a display panel 14, a quantum dot composite film 15, a diffusion plate 16 and a support column 17. The quantum dot composite film 15 is adhered to a side of the display panel 14 close to a bottom surface of the back plate 11, and the support column 17 is configured to support the diffusion plate 16, so that a gap is between the light source structure 13 and the diffusion plate 16. The quantum dot composite film 15 is configured improve a color gamut of the display panel 14. However, the inventors of the present disclosure noticed that, when external water vapor and the like enter the quantum dot composite film, it can cause quantum dot failure, so as to cause adverse problems such as module image bluing caused by an edge failure of the quantum dot composite film, so that the quality of a display module image is reduced to further affect the color gamut of the display panel. The display module 10 can improve the bright edge problem of the film in the periphery, and by removing the separately arranged diffusion plate 16, the problem of the edge dark frame caused by the expansion space reserved between the diffusion plate 16 and the middle frame 12 can be solved, which can improve the image quality and market competitiveness of the product.

In addition, the inventors of the present disclosure also noticed that, the main function of the diffusion plate is to increase the haze of the display panel, and the diffusion plate has a certain thickness and a certain weigh. Therefore, it can consider integrating a film layer having a haze adjustment function to the quantum dot composite film, to remove the diffusion plate, and thus it is not necessary to support the diffusion plate, to further remove the support column, so that the structure of the display module is simpler. Moreover, the film layer having the haze adjustment function is integrated into the quantum dot composite film, which can reduce the complexity of the assembling process, to improve the efficiency of assembling the display module, so as to save work time of the production line.

At least one embodiment of the present disclosure provides a display module. The display module includes a display panel, and the display panel includes a liquid crystal cell and a quantum dot composite film. The quantum dot composite film is provided on a main surface of the liquid crystal cell. The display panel further includes a middle frame. The middle frame is provided on a side of the quantum dot composite film away from the liquid crystal cell. An edge of the quantum dot composite film is provided with a sealing structure, and the sealing structure can prevent the water vapor from entering the quantum dot composite film, to reduce the risk of adverse problems such as module image bluing produced by an edge failure of the quantum dot composite film, which can avoid reducing the quality of the display module image, and will not affect the color gamut of the display panel.

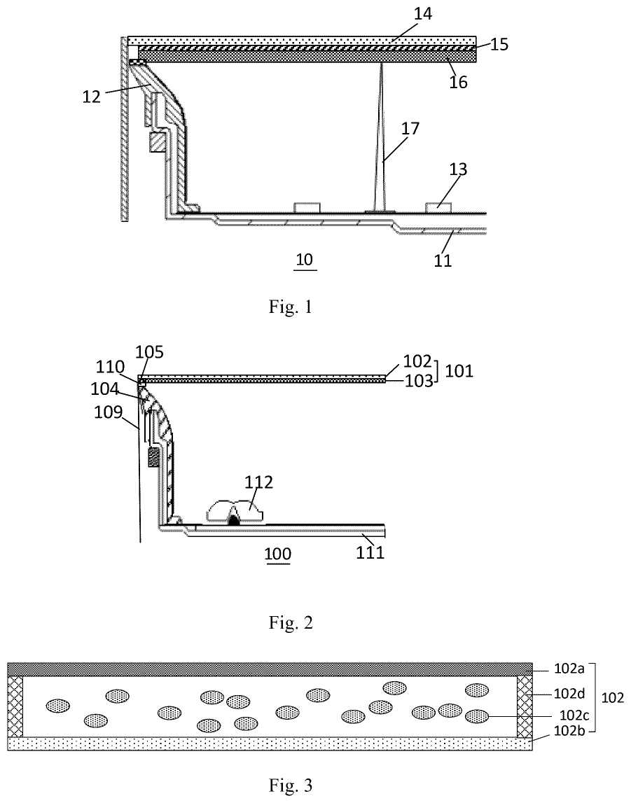

For example, FIG. 2 is a schematic diagram of a section structure of a display module provided by at least one embodiment of the present disclosure. As illustrated in FIG. 2, the display module 100 includes a display panel 101. The display panel 101 includes a liquid crystal cell 102 and a quantum dot composite film 103. The quantum dot composite film 103 is provided on a main surface of the liquid crystal cell 102. The display module 100 further includes a middle frame 104. The middle frame 102 is provided on a side of the quantum dot composite film 103 away from the liquid crystal cell 102, and an edge of the quantum dot composite film 103 is provided with a sealing structure 105. The sealing structure 105 can prevent water vapor from entering in the quantum dot composite film 103 to cause the quantum dot failure.

For example, a material of the sealing structure 105 includes UV curing adhesive. The UV curing adhesive can entirely cover the edge of the quantum dot composite film, and in a direction perpendicular to the main surface of the display panel 101, that is in a height direction, a height of the UV curing adhesive is not beyond a height of the entire quantum dot composite film.

For example, as illustrated in FIG. 2, a distance between the sealing structure 105 and an edge of the liquid crystal cell located at a same side as the sealing structure 105 is from 0 to 0.2 mm. For example, the distance between the sealing structure 105 and the edge is 0, 0.1 mm or 0.2 mm, which is not limited by the embodiments of the present disclosure herein. In a case where the sealing structure 105 and the edge of the liquid crystal cell 102 located at the same side of the sealing structure 105 is larger than 0.2 mm, the display region will be reduced, which will affect the display quality.

For example, as illustrated in FIG. 2, in the direction perpendicular to the main surface of the display panel 101, a thickness of the sealing structure 105 is equal to or substantially equal to a thickness of the quantum dot composite film 103, and the sealing structure 105 completely covers the edges of the quantum dot composite film 103, so that the sealing structure 105 can completely seal the edges of the quantum dot composite film 103, furthermore, it can prevent water vapor from entering the quantum dot composite film 103 and causing quantum dot failure, thereby avoiding the generation of blue edges due to quantum dot failure.

For example, the middle frame 104 can be made of aluminum material or plastic material. In a case where the material of the middle frame 104 is the aluminum material, it can be formed by extrusion molding; and in a case where the material of the middle frame 104 is the plastic material, it can be formed by injection molding. The main function of the middle frame 104 is to support the display panel, and the surface of the middle frame 104 used to support the display panel can also be used as a surface for coating an adhesive.

For example, as illustrated in FIG. 2, the display module 100 further includes a back plate 111 and a light source structure 112 provided on the back plate 111. The light source structure 112 can provide a backlight source for the display of the display panel 101. In an example, in order to have a good light emitting efficiency and a good light emitting brightness, the light source structure 112 includes a blue light emitting diode (LED) or a blue Mini-LED. The blue light emitting diode has a blue light emitting diode chip and yellow fluorescence material. For example, the yellow fluorescence material is yttrium aluminum garnet doped with cerium (YAG:Ce). The blue light emitted from the blue light emitting diode chip passes through the yellow fluorescence material to mix with the yellow light emitted from the yellow fluorescence material, so that the backlight source can finally emit white light.

For example, FIG. 3 is a schematic diagram of a section structure of a liquid crystal cell provided by at least one embodiment of the present disclosure. As illustrated in FIG. 3, the liquid crystal cell 102 includes a first substrate 102a and a second substrate 102b facing to each other and separated from each other and a liquid crystal layer 102c between the first substrate 102a and the second substrate 102b. Although not illustrated, a plurality of gate lines and a plurality of data lines are formed on an inner surface of the first substrate 102a (for example, an array substrate). The plurality of gate lines and the plurality of data lines cross with each other to define pixel regions, and thin film transistors (TFT) are connected with both of the gate lines and the data lines. A transparent electrode of each of the pixel regions is connected with a source electrode or a drain electrode of the corresponding thin film transistor (TFT). In addition, a black matrix covering the gate lines, the data lines and the thin film transistors is formed on an inner surface of the second substrate 102b (for example, a color filter substrate), and color filter layers including a red color filter, a green color filter and a blue color filter are formed on the black matrix. For example, a transparent common electrode is formed on the color filter layer.

For example, as illustrated in FIG. 3, a first orientation layer (not illustrated in FIG. 3) is formed between the first substrate 102a and the liquid crystal layer 102c, and a second orientation layer (not illustrated in FIG. 3) is formed between the second substrate 102b and the liquid crystal layer 102c. In addition, a sealing pattern 102d is formed between an edge portion of the first substrate 102a and an edge portion of the second substrate 102b. For example, the sealing pattern 102d is a sealant pattern, to prevent leakage of the liquid crystal layer. For example, the sealing pattern 102d is not limited to the heat curing sealant or the UV light curing sealant. An accommodation space is formed between the sealant pattern 102d, the first substrate 102a and the second substrate 102b, and the liquid crystal layer 102c is arranged in the accommodation space.

For example, as illustrated in FIG. 3, a first polarizer (not illustrated in FIG. 3) and a second polarizer (not illustrated in FIG. 3) are respectively formed on outer surfaces of the first substrate 102a and the second substrate 102b, those are surfaces of the first substrate 102a and the second substrate 102b away from the liquid crystal layer 102c, which are not limited in embodiments of the present disclosure.

For example, a material of the first substrate 102a and a material of the second substrate 102b can include glass, plastic or other transparent material, and the material of the first substrate 102a and the material of the second substrate 102b can be the same or different from each other.

It should be noted that, in the structure illustrated in FIG. 3, the liquid crystal display panel is formed by the liquid crystal layer 102c as the display medium. In the embodiment of the present disclosure, the display medium can also be made of organic electroluminescent material or electrophoretic material, which is not limited in the embodiment of the present disclosure.

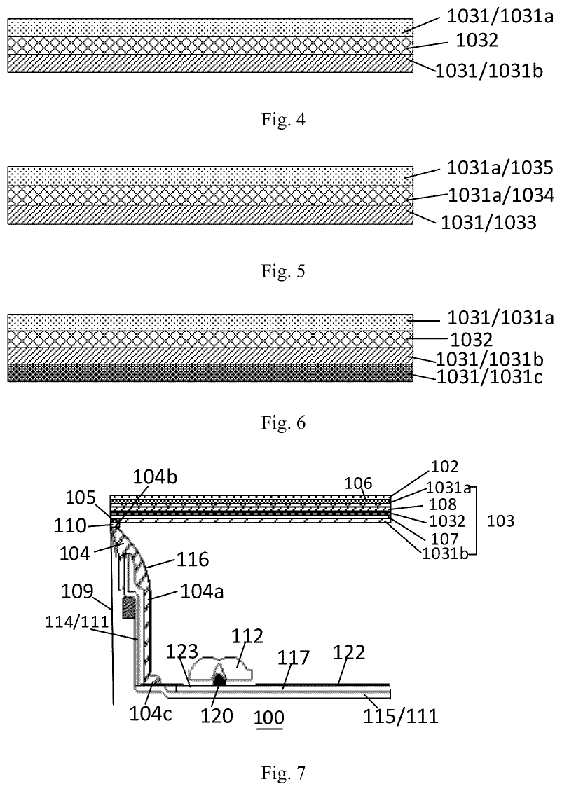

For example, FIG. 4 is a schematic diagram of a section structure of a quantum dot composite film provided by at least one embodiment of the present disclosure. Combining FIG. 2 and FIG. 4, the quantum dot composite film 103 includes a function layer 1031 and a quantum dot film layer 1032 which are stacked. The function layer 1031 can be a single-layer structure, and can also be a multiple-layer structure. In a case where the function layer 1031 is the single layer structure, the function layer 1031 can be a film layer having a brightness adjustment function and can also be a film layer having a haze adjustment function.

For example, as illustrated in FIG. 4, the function layer 1031 is the multiple-layer structure, and the function layer 1031 at least includes a first brightness enhancement layer 1031a and a haze adjustment layer 1031b. The quantum dot film layer 1032 is sandwiched between the first brightness enhancement layer 1031a and the haze adjustment layer 1031b. The first brightness enhancement layer 1031a is configured to enhance the brightness of the display module 100, and the haze adjustment layer 1031b is configured to adjust the haze of the display module 100.

For example, combining FIG. 2 and FIG. 4, the first brightness enhancement layer is provided on a side of the haze adjustment layer 1031b close to the liquid crystal cell 102, that is, the first brightness enhancement layer 1031a is sandwiched between the haze adjustment layer 1031b and the liquid crystal cell 102. The light emitted from a light source structure 112 firstly reach the haze adjustment layer 1031b for adjusting the haze, and after the light passes through the haze adjustment layer 1031b, the light reaches the first brightness enhancement layer 1031a for adjusting the brightness.

For example, in an example, the main function of the quantum dot film layer 1032 is to improve the color gamut of the display module 100. The quantum dot film layer 1032 includes a red quantum dot material, a green quantum dot material and a base material layer. The red quantum dots and the green quantum dots in the quantum dot film layer are excited by the blue light source to generate red light and green light. The red light and the green light are then mixed with the blue light, to form white light with high purity, so as to enhance the color gamut of the display module 100.

For example, FIG. 5 is a schematic diagram of a section structure of a first brightness enhancement layer provided by at least one embodiment of the present disclosure. Combining FIG. 2 and FIG. 5, the first brightness enhancement layer 1031a has a multiple-layer structure that a plurality of layers are stacked. In a direction from the quantum dot composite film 103 to the liquid crystal cell 102, the first brightness enhancement layer 103a includes a brightness enhancement film 1033, a diffusion film 1034 and a prism film 1035 which are stacked in sequence. For example, the brightness enhancement film 1033, the diffusion film 1034 and the prism film 1035 can be stacked in sequence on a transparent base substrate. The transparent base substrate should have a strength, and the performance of resistance to thermal expansion and contraction. For example, the transparent base substrate may be a glass base substrate. The brightness enhancement film 1033 can achieve an improvement of brightness. The diffusion film 1034 can achieve the diffusion of the light incident on it. The prism film 1035 can achieve the refraction of the light. It should be understood that, in other illustrative embodiments, the first brightness enhancement layer 1031a can also be other structures. For example, the brightness enhancement film 1033, the diffusion film 1034 and the prism film 1035 can be stacked in other sequences, or in an example, the first brightness enhancement layer 1031a can only include the diffusion film 1034 and the prism film 1035 etc., which belongs to the protection scope of the embodiments of the present disclosure.

It should be noted that, the prism film 1035 is an optical film material. A surface of the optical film material has a peak-like structure, and the peak-like structure has the function of converging light, so that the brightness of the display module in viewing at the front view angle can be enhanced.

For example, FIG. 6 is a schematic diagram of a section structure of another function layer provided by at least one embodiment of the present disclosure. As illustrated in FIG. 6, the function layer 1031 further includes a second brightness enhancement layer 1032c provided on a side of the first brightness enhancement layer 1031 away from the quantum dot film layer 1032, and the second brightness enhancement layer 1031c is configured to further improve the brightness of the display module 100. The multiple-layer structure that a plurality of layers are stacked and the quantum dot film layer 1032 included in the function layer 1031 can be directly adhered to the liquid crystal cell 102 as a whole, so that the complexity of the assembly process can be reduced, to improve the assembly efficiency of the display module, so as to save work time of the product line.

For example, FIG. 7 is a schematic diagram of a section structure of another display module provided by at least one embodiment of the present disclosure. As illustrated in FIG. 7, the quantum dot composite film 103 is adhered to the main surface of the liquid crystal cell 102 by the first adhesive 106. In the quantum dot composite film 103, the haze adjustment layer 1031b is completely adhered to a side of the quantum dot film layer 1031 away from the display panel 101 by a second adhesive 107, the first brightness enhancement 1031a is completely adhered to the quantum dot film layer 1032 close to the display panel 101 by a third adhesive 108, so that the haze adjustment layer 1031b is completely adhered to the quantum dot film layer 1032 away from the display panel 101 by the second adhesive 107, the first brightness enhancement layer 1031a, the quantum dot film layer 1032 and the haze adjustment layer 1031b are bonded as a whole to adhere to the main surface of the liquid crystal cell 102, that is, the first brightness enhancement layer 1031a, the quantum dot film layer 1032 and the haze adjustment layer 1031b are bonded to an integrity structure and are adhered to the main surface of the liquid crystal cell 102 by the first adhesive 106, and the bonding of the two adjacent layers are all plane bonding, so that the bonding of two adjacent layers is more tight.

For example, as illustrated in FIG. 7, the first adhesive 106, the second adhesive 107 and the third adhesive 108 each includes at least one of the heat melt adhesive and the UV curing adhesive. The first adhesive 106, the second adhesive 107 and the third adhesive 108 each is transparent adhesive, and the transparent adhesive has a stronger transmittance. The light from the light exiting side of the quantum dot composite film 103 can pass through the transparent adhesive to transmit to the liquid crystal cell 102, to avoid the problem of poor display effect caused by the dark border of the display panel 101.

For example, in an example, the first adhesive 106, the second adhesive 107 and the third adhesive 108 each is an optical adhesive material with haze, and a range of the haze is from about 50% to 95%.

For example, in an example, as illustrated in FIG. 7, the haze of the haze adjustment layer 1031b is from about 50% to 95%. For example, the haze of the haze adjustment layer is 50%, 55%, 65%, 70%, 75%, 80%, 85%, 90% and 95%.

For example, in an example, the function of the haze adjustment layer 1031b is to block light, to increase the overall haze of the display panel 101.

It should be noted that, haze is the percentage of transmitted light intensity that deviates from the incident light by more than 2.5° to the total transmitted light intensity. The higher the haze, the lower the gloss and the transparency of the film, especially the lower of the imaging degree. A parallel beam of light from a standard “c” light source vertically illuminates to a transparent film or a translucent film, a sheet or a plate. Due to the scattering inside the material and on the surface of the material, haze is the percentage of the scattered light flux Td that deviates from the incident direction by more than 2.5° and the transmitted light flux T2 that passes through the material.

For example, in an example, the haze adjustment layer 1031b is made of polyethylene terephthalate, and the surface of the haze adjustment layer 1031b includes diffusion particles with an average particle diameter of 3 μm to 50 μm. For example, the material of the diffusion particles includes transparent particles such as silicon dioxide and titanium dioxide. The average particle diameter of the diffusion particles is 3 μm, 5 μm, 10 μm, 15 μm, 20 μm, 25 μm, 30 μm, 35 μm, 40 μm, 45 μm or 50 μm, and so on, which is not limited by the embodiments of the present disclosure.

For example, in an example, as illustrated in FIG. 2 and FIG. 7, side surfaces of the display panel 101 and the middle frame 104 are arranged with a light shielding tape 109. The light shielding tape 109 is configured to fix the display panel 101, so that the display panel 101 can keep a stable status. For example, the light shielding tape 109 can be the UV curing adhesive, the hot melt adhesive, or a combination of the UV curing adhesive and the hot melt adhesive, or the double-sided adhesive. The embodiments of the present disclosure do not limit to this, as long as it can fix the display panel 101.

For example, as illustrated in FIG. 2 and FIG. 7, the material of the light shielding tape 109 is black terephthalic acid and ethylene glycol polycondensation material. The main function of the light shielding tape 109 is to block the edge of the display panel 101 and the light leakage from the backlight module, to avoid the light leakage of the backlight module, and meanwhile have the function of good appearance as the outer surface.

For example, as illustrated in FIG. 2 and FIG. 7, the display panel 101 is connected with the middle frame 104 by a fourth adhesive 110. The fourth adhesive 110 is the pressure sensitive adhesive, the hot melt adhesive or the UV curing adhesive.

For example, as illustrated in FIG. 2 and FIG. 7, the manner of adhering the display panel 101 and the middle frame 104 is the manner of frame adhering. The frame adhering is that the fourth adhesive 110 is adhered around the perimeter of display panel 101 and the perimeter of middle frame 104.

For example, in an example, a thickness of the fourth adhesive 110 in a direction perpendicular to the main surface of the display panel 101 is from 0.2 mm to 0.5 mm. For example, the thickness of the fourth adhesive 110 is 0.2 mm, 0.3 mm, 0.4 mm, or 0.5 mm. A length of the fourth adhesive 110 in parallel to the main surface of the display panel 101 is from 0.5 mm to 1 mm. For example, the length of the fourth adhesive 110 is 0.5 mm, 0.6 mm, 0.7 mm, 0.8 mm, 0.9 mm or 1 mm.

For example, as illustrated in FIG. 7, the middle frame 104 is aluminum extrusion material. The aluminum extrusion material has a flat surface, so that the middle frame 104 has a flat surface. It should be understood that, in other exemplary embodiments, the middle frame 104 can also be a plastic frame.

For example, as illustrated in FIG. 7, the back plate 111 of the display module 100 can further include a first sub-back plate 115 in parallel to or substantially in parallel to the main surface of the display panel 101. The light source structure 112 is provided on a side of the first sub-back plate 115 close to the display panel 101. For example, the first sub-back plate 115 is a bottom plate.

For example, as illustrated in FIG. 7, a light emitting unit 120 is provided between the light source structure 112 and the first sub-back plate 115, so that the light emitted from the light source structure 112 can incident on the display panel 101.

For example, in an example, the light emitting unit 120 can be arranged on the first sub-back plate 115 by means of double-sided adhesive connection or screw fixed connection etc., which is not limited by embodiments of the present disclosure.

For example, the back plate 111 further includes a second sub-back plate 114 in parallel to or substantially in parallel to an extension direction of the middle frame 104. and the second sub-back plate 114 is a side plate. In an example, the middle frame 104 and the second sub-back plate 114 can be connected by a connection part (not illustrated in figures). The connection part can a combination of a bolt and a screw or can be snap-in connection.

For example, in an example, as illustrated in FIG. 7, the middle frame 104 is supported and fixed by the second sub-back plate 114 of the back plate 111. By providing the structure, the overall rigidity of the display module 100 can be enhanced. For example, as illustrated in FIG. 7, the side of the middle frame 104 close to the light source structure 112 has an arc surface protruding to a side of the light source structure 112. The arc surface is provided with an optical film layer 116. The optical film layer 116 is configured to guide the light emitted from the light source structure 112 and incident on the optical film layer 116 to the display panel included in the display module formed subsequently, to provide a backlight source for the display panel. For example, the arc surface of the light source structure 112 protruding to the side of the light source structure 112 facilitates the guidance of the light.

For example, as illustrated in FIG. 7, the middle frame 104 can include a support main body 104 (including an arc surface) with an arc profile and a first support part 104b and a second support part 104c connected to two sides of the main support main body 104a. The first support part 104b supports the display panel of the display module 110 formed subsequently. The second support part 104c is supported on the first sub-back plate 115 of the back plate 111. In other illustrative embodiments, the middle frame 104 can further has more structures for selection, which belongs the protection scope of the present disclosure.

For example, a width of the middle frame 104 close to the surface of the display panel 101 is from 0.2 mm to 0.5 mm. The width is 0.2 mm, 0.3 mm, 0.4 mm, or 0.5 mm. In combination with FIG. 6, a width of the first support part 104b close to the surface of the display panel 101 is from 0.2 mm to 0.5 mm.

For example, as illustrated in FIG. 7, a circuit board 117 can be provided between the bottom plate 115 and the light source structure 112, and the light source structure 112 is fixed on the circuit board 117. The circuit board 117 is configured to provide the turn-on voltage to the light source structure 112.

For example, in an example, as illustrated in FIG. 7, a reflection film 122 is provided on a side of the first sub-back plate 115 close to the display panel 101. The reflection film 122 is provided with an interval region 123, and the light source structure 112 is provided in the interval region 123. The reflection film 122 can make the light emitted from the light source structure 112 to be fully utilized, to improve the working efficiency of the display module 100.

For example, in an example, the reflection film 122 is connected to the first sub-back plate 115 by the double-sided adhesive. The light source structure 112 is provided in the interval region 123 by means of the double-sided adhesive or the screw fixing.

For example, the material of the back plate 111 is either electroplated galvanized steel sheet or hot-dip galvanized steel sheet. The main function of the back plate 111 is to fix the light source structure, the middle frame 104 and other structures, so as to have a function of supporting the whole display module 100.

For example, other structures of the display module 100 can be found in the relevant descriptions of the conventional display module, which will not be repeated herein.

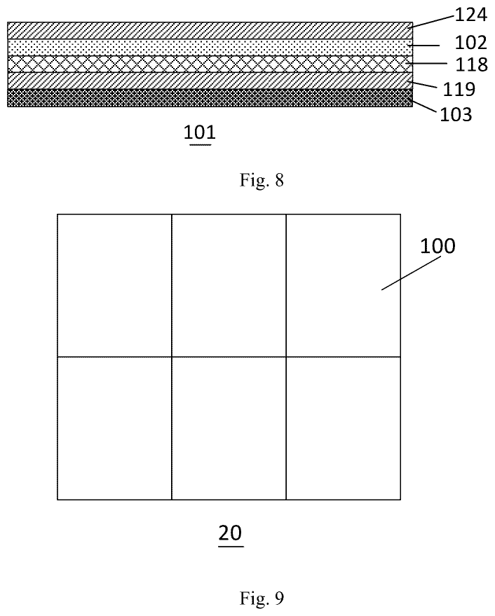

For example, FIG. 8 is a schematic diagram of a section structure of a display panel provided by at least one embodiment of the present disclosure. As illustrated in FIG. 8, the display panel 101 further includes a first polarizer 118 provided on a side of the liquid crystal cell 102 close to the quantum dot composite film 103, and the quantum dot composite film 103 and the first polarizer 118 are adhered by the first adhesive 119. In an example, the first polarizer 118 can be a wire grating polarizer, and the light with specific polarization direction can pass through the first polarizer 118.

For example, the first adhesive 119 is a heat curing adhesive or a photosensitive adhesive. The photosensitive adhesive is UV curing adhesive, which is a type of adhesive that must be cured by ultraviolet light radiation, and it can be used as an adhesive.

For example, as illustrated in FIG. 8, the display panel 101 further includes a second polarizer 124 provided on a side of the liquid crystal cell 102 away from the quantum dot composite film 103. In an example, the second polarizer 124 can be a wire grating polarizer, and the light with specific polarization direction can pass through the second polarizer 124.

For example, the first polarizer 118 and the second polarizer 124 can also be reflective polarizers, the first polarizer 118 selectively reflects the polarization light of the display module, so that the obtained light is not absorbed by the first polarizer 118 to improve the utilization of full-view light and increase the brightness of the display module by 30% to 40%.

At least one embodiment of the present disclosure further provides a display device. For example, FIG. 9 is a schematic diagram of a plane structure of a display device provided by at least one embodiment of the present disclosure. As illustrated in FIG. 9, the display device 20 includes a splicing screen formed by a plurality of display modules provided by any one of the above embodiments. Although the display device illustrated in FIG. 8 includes a splicing screen spliced by six display modules 100, the embodiments of the present disclosure are not limited to this. More display modules 100 may be included, for example, two, four, nine and so on.

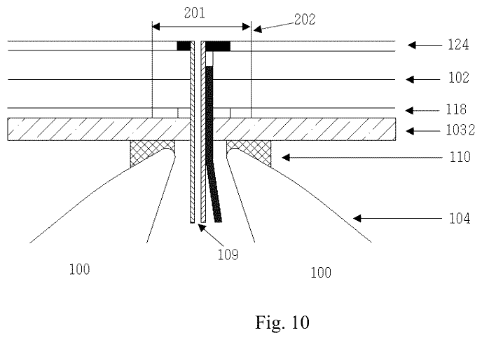

For example, FIG. 10 is a schematic diagram of a section structure of a display device provided by at least one embodiment of the present disclosure. As illustrated in FIG. 10, a splicing seam 201 is between the display regions 202 of adjacent display modules 100, and the splicing seam 201 is non-image display region.

For example, as illustrated in FIG. 10, the adjacent display modules 100 are spliced by the light shielding tapes included in the display modules 100, that is, the light shielding tapes not only have a function of fixing the display panel, but also can have a function of shielding light and connecting the adjacent display modules 100. In order to distinguish the light shielding tapes of different display modules, the adjacent light shielding tapes 109 are not combined together, and there is a gap between the adjacent light shielding tapes 109. In an actual product, the light shielding tapes 109 of the adjacent display modules are bonded together as a whole.

For example, as illustrated in FIG. 10, the second polarizer 1024 and the first polarizer 118 can be adhered to an upper side and a bottom side of the liquid crystal cell 102 respectively. In an example, the function layer 1031 included in the quantum dot composite film 103 of the above embodiment can be integrated on the first polarizer 118, and the quantum dot film layer 1032 included in the quantum dot composite film 103 can be formed on a side of the first polarizer 118 away from the liquid crystal cell 102. The middle frames 104 of the adjacent display modules 100 are all adhered on the quantum dot film layer 1032 by the fourth adhesive 110.

For example, in a first implementation mode, a process of the quantum dot composite film 103 forming on the main surface of the liquid crystal cell 102 includes: attaching the quantum dot film layer roll and the first polarizer roll to form a composite material roll; cutting the composite material roll to form a composite material sheet, attaching the composite material sheet to the second substrate, cutting the edges of the composite material sheet by laser, and connecting the composite material sheet with a chip on film and a circuit board, and finally forming a product by adhering of the quantum dot composite film and the liquid crystal cell.

The above first implementation mode is just applicable to the solution of the composite film not using the diffusion film. A main advantage of the above solution is that the roll is adhered and then the roll is cut to form a sheet, and the production efficiency is high. In a case that the composite film using the diffusion film, a length direction of the roll of the diffusion film is a direction of light transmission axis, and a length direction of the roll of the first polarizer is a direction of light absorption axis. The roll of the diffusion film and the roll of the first polarizer are adhered, and since the direction of the light transmission axis of the diffusion film is different from the direction of the light transmission axis of the first polarizer, the composite material formed by adhering the diffusion film and the first polarizer may not transmit light, that is, the image of the display module is always in a dark state.

In the above first implementation mode, a size of the composite material sheet is larger than a profile size of the liquid crystal cell. When the composite material sheet is adhered to the liquid crystal cell, the center or the edge of the liquid crystal cell is selected to be positioned. The composite material sheet and the liquid crystal cell are adhered and then are cut by a laser device, so that the size of the composite material sheet finally produced is slightly less than the size of the liquid crystal cell, and a distance between the edge of the composite material sheet and the edge of the liquid crystal cell is within 0.2 mm. If the distance is too large, it will cause that the edge of the composite material sheet is too close to the display region, and will cause poor image quality of the display modules such as bright edges of the composite material sheet. If the edge of the composite material sheet is beyond the edge of the liquid crystal cell, it will cause the edge of the chip on film contacts the edge of the composite material sheet after bonding the chip on film, which is prone to scratching the chip on film, thereby affecting the reliability of the display module.

For example, in a second implementation mode, the process of forming the quantum dot composite film 103 on the main surface of the liquid crystal cell 102 includes: adhering the quantum dot film layer sheet and the first polarizer sheet, to form composite material sheet; cutting the composite material sheet, and then adhering the composite material sheet and the second substrate, cutting an edge of the composite material sheet by laser and connecting the composite material sheet with the chip on film and the circuit board, and finally forming the product of adhering the quantum dot composite film and the liquid crystal cell.

The above second implementation mode is applicable to a solution having composite film of the diffusion film, or applicable to a case of the quantum dot film layer roll not matching the first polarizer roll in size and poor yield of composite material sheet. The solution has wide applicability, but the production efficiency of adhering the quantum dot film layer sheet and the first polarizer sheet and then cutting is not higher than the efficiency of the above solution of adhering the quantum dot film layer roll and the first polarizer roll directly.

The main difference between the second implementation mode and the first implementation mode is the first two processes, that is, the adhering method and the cutting method of the composite film and the second polarizer. The process of the second implementation mode is as follows: cutting the composite film with a diffusion film into a sheet, cutting the second polarizer into a sheet, and rotating the second polarizer or the composite film with the diffusion film by 90 degrees (that is, ensuring the transmission axis of the diffusion film and the transmission axis of the second polarization are consistent) and then adhering the composite film sheet with the diffusion film and the second polarizer sheet, and then, the bonding structure of the composite film sheet with the diffusion film and the second polarizer sheet is cut by using a knife mold or laser equipment, for example, according to the cutting accuracy requirements, selecting the knife mold or the laser cutting method. Generally, the laser cutting precision is high, up to ±0.1 mm range.

For example, the process of forming the final display panel by the second implementation mode includes: cell-assembling the first substrate and the second substrate, forming the first polarizer and the second polarizer on the outer surfaces of the first base substrate and the second substrate respectively, adhering the composite film sheet and the second polarizer, and then cutting the edge of the composite material sheet by laser, connecting the composite material sheet with the chip on film and the circuit board respectively, and finally forming the product of adhering the quantum dot composite film and the liquid crystal cell.

The above second implementation mode is applicable to the solution of the composite films with the diffusion film. The main advantage of the second implementation mode is that after manufacturing the liquid crystal cell, the first polarizer, and the second polarizer, adhering the composite film directly without the need for separately manufacturing the composite material of the composite film and second polarizer, thereby simplifying the overall adhering process and improving the product yield.

For example, the display device includes any one of the above display modules, and the display device in the embodiments of the present disclosure can be: a display, an OLED panel, an OLED TV, an electronic paper, a mobile phone, a tablet computer, a laptop computer, a digital photo frame, a navigation and other products or components having a display function.

The display device provided by the embodiments of the present disclosure has the same technical features and working principle as the aforementioned display modules, which will not be repeated in the embodiments of the present disclosure.

The display module and the display device provided by at least one embodiment of the present disclosure have at least one beneficial technical effect as follows.

(1) In the display module provided by at least one embodiment of the present disclosure, an edge of the quantum dot composite film is provided with a sealing structure, and the sealing structure can prevent the water vapor from entering the quantum dot composite film, to reduce the risk of adverse problems such as module image bluing produced by an edge failure of the quantum dot composite film, which can avoid reducing the quality of the display module image, and will not affect the color gamut of the display panel.

In the display module provided by at least one embodiment of the present disclosure, the multiple-layer structure that a plurality of layers are stacked and the quantum dot film layer included in the function layer can be directly adhered to the liquid crystal cell as a whole, so that the complexity of the assembly process can be reduced, to improve the assembly efficiency of the display module, so as to save work time of the product line.

The following statements should be noted:

(1) The accompanying drawings involve only the structure(s) in connection with the embodiment(s) of the present disclosure, and other structure(s) can be referred to common design(s).

(2) For clarity, in the drawings used to describe the embodiments of the present disclosure, the thickness of the layers or regions is enlarged or reduced, that is these drawings are not drawn to actual proportions.

(3) In case of no conflict, the embodiments of the present disclosure and the features in the embodiments can be combined with each other to obtain new embodiments.

What have been described above are only exemplary embodiments of the present disclosure and are not intended to limit the scope of protection of the present disclosure, and the protection scope of the present disclosure should be subject to the protection scope of the claims.

1. A display module, comprising:
a display panel, comprising a liquid crystal cell and a quantum dot composite film, wherein the quantum dot composite film is arranged on a main surface of the liquid crystal cell; and
a middle frame, arranged on a side of the quantum dot composite film away from the liquid crystal cell,
wherein a sealing structure is arranged on an edge of the quantum dot composite film.

2. The display module according to claim 1, wherein the quantum dot composite film comprises a function layer and a quantum dot film layer which are stacked.

3. The display module according to claim 2, wherein the function layer at least comprises a first brightness enhancement layer and a haze adjustment layer, the quantum dot film layer is sandwiched between the first brightness enhancement layer and the haze adjustment layer, the first brightness enhancement layer is configured to increase brightness of the display module, and the haze adjustment layer is configured to adjust haze of the display module.

4. The display module according to claim 3, wherein the first brightness enhancement layer is arranged on a side of the haze adjustment layer close to the liquid crystal cell.

5. The display module according to claim 4, wherein in a direction from the quantum dot composite film to the liquid crystal cell, the brightness enhancement layer comprises a brightness enhancement film, a diffusion film, and a prism film stacked sequentially.

6. The display module according to any one of claims 3 to 5, wherein the function layer further comprises a second brightness enhancement layer arranged on a side of the first brightness enhancement layer away from the quantum dot film layer, and the second brightness enhancement layer is configured to increase the brightness of the display module.

7. The display module according to any one of claims 3 to 6, wherein the quantum dot composite film is attached to the main surface of the liquid crystal cell by a first adhesive.

8. The display module according to claim 7, wherein the haze adjustment layer is entirely adhered to a side of the quantum dot film layer away from the display panel by a second adhesive, and the first brightness enhancement layer is entirely attached to a side of the quantum dot film layer close to the display panel by a third adhesive.

9. The display module according to claim 8, wherein the first adhesive, the second adhesive and the third adhesive comprise at least one of hot meld adhesive and UV curing adhesive respectively.

10. The display module according to any one of claims 3 to 9, wherein a haze of the haze adjustment layer is from about 50% to 95%.

11. The display module according to any one of claims 3 to 10, wherein the haze adjustment layer is made of polyethylene terephthalate, a surface of the haze adjustment layer comprises diffusion particles and an average particle diameter of the diffusion particles is from 3 μm to 50 μm.

12. The display module according to any one of claims 1 to 11, wherein a side surface of the display panel and a side surface of the middle frame are provided with a light shielding tape.

13. The display module according to any one of claims 1 to 12, wherein the display panel is connected with the middle frame by a fourth adhesive.

14. The display module according to claim 13, wherein a thickness of the fourth adhesive in a direction perpendicular to the main surface of the display panel is from 0.2 mm to 0.5 mm, and a length of the fourth adhesive in a direction parallel to the main surface of the display panel is from 0.5 mm to 1 mm.

15. The display module according to any one of claims 1 to 14, wherein a width of the middle frame close to a surface of the display panel is from 0.2 mm to 0.5 mm.

16. The display module according to any one of claims 1 to 15, wherein a distance between the sealing structure and an edge of the liquid crystal cell located in a same side as the sealing structure is from 0 to 0.2 mm.

17. The display module according to any one of claims 1 to 16, wherein in a direction perpendicular to the main surface of the display panel, a thickness of the sealing structure is equal to or substantially equal to a thickness of the quantum dot composite film, and the sealing structure covers an edge of the quantum dot composite film.

18. The display module according to any one of claims 1 to 17, wherein the display panel further comprises a first polarizer provided on a side of the liquid crystal cell close to the quantum dot composite film, and the quantum dot composite film is adhered to the first polarizer by a first adhesive.

19. The display module according to claim 18, wherein the display panel further comprises a second polarizer provided on a side of the liquid crystal cell away from the quantum dot composite film.

20. The display module according to any one of claims 1 to 19, further comprising a light source structure and a back plate, wherein the back plate comprises a first sub-back plate in parallel to or substantially in parallel to the main surface of the display panel, and the light source structure is arranged on a side of the first sub-back plate close to the display panel.

21. The display module according to claim 20, wherein a light emitting unit is provided between the light source structure and the first sub-back plate.

22. The display module according to claim 20 or 21, wherein a reflection film is provided on a side of the first sub-back plate close to the display panel, the reflection film has an interval region, and the light source structure is arranged in the interval region.

23. The display module according to any one of claims 20 to 22, wherein the back plate further comprises a second sub-back plate in parallel to or substantially in parallel to an extension direction of the middle frame, and the middle frame is connected with the second sub-back plate by a connection part.

24. A display device, comprising a splicing screen formed by a plurality of display modules according to any one of claims 1 to 23.
